(19) United States
(12) Patent Application Publication
(10) Pub. No.: US 2026/0044893 A1
(43) Pub. Date: Feb. 12, 2026

(54) METHOD AND SYSTEM FOR DETERMINING CREDITWORTHINESS OF A USER

(71) Applicant: L&T Finance Limited, Mumbai (IN)

(72) Inventors: Debarag N. Banerjee, Los Altos Hills, CA (US); Gaurav Bansal, Mumbai (IN); Rishikesh Kadam, Mumbai (IN); Amit Varshney, Mumbai (IN); Sourav Thakur, Mumbai (IN); Shubham Varnkar, Mumbai (IN); Balaji Babu Shaik, Bangalore (IN); Mohammed Rahil Khan, Maharashtra (IN)

(21) Appl. No.: 19/293,397

(22) Filed: Aug. 7, 2025

(30) Foreign Application Priority Data
Aug. 7, 2024 (IN) 202421059713

(51) Int. Cl. G06Q 40/03

(52) U.S. Cl. CPC G06Q 40/033

(57) ABSTRACT

In one embodiment, a method and a system for determining creditworthiness of a user are provided. The method comprises receiving user related data, wherein the user related data comprises financial data, behavior data and location information of user's residence, determining a lifestyle index of the user based on the user related data, and determining creditworthiness of the user based on the lifestyle index.

### FIELD OF INVENTION

Embodiments of the present invention generally relate to determining creditworthiness of the user and more particularly relate to determining creditworthiness of the user based on the lifestyle of the user.

### BACKGROUND OF THE INVENTION

User lifestyle is required to be understood for many companies directly dealing with users. For example, companies may be required to classify the users into different groups for providing tailored services to the users. Further, companies may be required to perform a real-time fraud detection for preventing fraudulent activities, for providing enhanced customer service to the users. In addition, companies may be required to develop predictive models based on the user behavior so that the future actions related to the fraudulent activities can be prevented.

Currently, companies have only a limited amount of data, for accessing the lifestyle of the users. In addition, even if they have data that potentially contains intelligence regarding understanding such lifestyle, no technique exists in prior art for utilizing such data for the purpose. For example, companies rely on limited data sources for accessing the user behavior. Usually, the historical data of the users and uniqueness of the users are accessed from various government and non-government data sources by the companies. These data sources generally are not updated periodically and hence the user behavior cannot be accessed accurately. Thus, there is a need in the art to improve the accuracy of evaluating lifestyle of the user by including more data sources as well as using more developed algorithms on existing data.

### SUMMARY OF THE INVENTION

The following presents a simplified summary of the subject matter in order to provide a basic understanding of some of the aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

In one embodiment, a method for determing creditworthiness of a user is provided. The method comprises receiving user related data, wherein the user related data comprises financial data, behavior data and location information of user's residence, determining a lifestyle index of the user based on the user related data, and determining creditworthiness of the user based on the lifestyle index.

In another embodiment, a system for determining creditworthiness of a user is provided. The system comprises a receiving module configured to receive user related data, wherein the user related data comprises financial data, behavior data and location information of user's residence, a lifestyle index determination module configured to determine a lifestyle index of the user based on the user related data, and a processor configured to determine creditworthiness of the user based on the lifestyle index.

### BRIEF DESCRIPTION OF THE ACCOMPANYING DRAWINGS

The following drawings are illustrative of particular examples for enabling systems and methods of the present disclosure, are descriptive of some of the methods and mechanism, and are not intended to limit the scope of the invention. The drawings are not to scale (unless so stated) and are intended for use in conjunction with the explanations in the following detailed description.

FIGS. 1 illustrates a system for determing creditworthiness of a user, in accordance with one embodiment of the present disclosure.

FIG. 2 illustrates a system for evaluating user lifestyle index according to location information of user's residence, in accordance with one embodiment of the present disclosure.

FIG. 3 illustrates a block diagram of a user device and a server device, in accordance with one embodiment of the present disclosure.

FIG. 4 illustrates an example embodiment for accessing aerial view of the location of a user, in accordance with one embodiment of the present disclosure.

FIG. 5 illustrates a front view of the location of the user, in accordance with one embodiment of the present disclosure.

FIG. 6 illustrates an interior view of the location of the user, in accordance with one embodiment of the present disclosure.

FIGS. 7(a) and 7(b) illustrates a flowchart of a method for evaluating user lifestyle index, in accordance with one embodiment of the present disclosure.

FIG. 8 illustrates a flowchart of a method for determining creditworthiness of a user, in accordance with one embodiment of the present disclosure.

Persons skilled in the art will appreciate that elements in the figures are illustrated for simplicity and clarity and may represent both hardware and software components of the system. Further, the dimensions of some of the elements in the figure may be exaggerated relative to other elements to help to improve understanding of various exemplary embodiments of the present disclosure. Throughout the drawings, it should be noted that like reference numbers are used to depict the same or similar elements, features, and structures.

### DETAILED DESCRIPTION

Exemplary embodiments now will be described. The disclosure may, however, be embodied in many different forms and should not be construed as limited to the embodiments set forth herein; rather, these embodiments are provided so that this disclosure will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

Many evaluators may require determination of the lifestyle of the user. For example, some financial evaluators may compute creditworthiness of the user by understanding the lifestyle of the user. In one embodiment, the evaluator may include, but not limited to, a company or a service provider or a machine. The company/service provider may include a financial company, a lending company, financial institution, etc. In this application, the term “evaluator” and “company” have been used interchangeably. Further, the user may include, but not limited to, a loan applicant or a borrower in some exemplary embodiments. For example, lenders may be required to determine the creditworthiness of a user, including but not limited to, amount of money that can be lent to the user, and/or the rate of interest at which such money to be lent at, and/or sometimes even to assess creditworthiness of the user to lent money. In one embodiment, the user may be the one who would require credit from the evaluator.

Lifestyle Index (LI) may be defined as the behaviours, value, mode of living, earning and spending money and intent to honour commitments. In other words, lifestyle Index assesses the behaviour of user from available data sets existing today, however the ability to evaluate same and come with Lifestyle Index is provided by way of usage of technological means. The conventional arts does not provide any means to identify the Lifestyle Index of a user. The present application overcomes the challenges of the conventional art by providing means to evaluate lifestyle index with objective and automated methods of digital data collection and process to establish Lifestyle Index, a digital lifestyle Index.

Lifestyle Index includes exterior lifestlyle index, interior lifestyle index, ariel lifestyle index, other lifestyle index (Psychometric LI Sustainability LI, etc.). Lifestyle Index together with Affluence Index, Credit Score & Other Data sets will ultimately lead us to assess the Creditworthiness (CW) of the user by objective, automated, technological means provided in this application. Affluence may be defined as level of wealth/assets a person owns or controls. Affluence is not sole factor to determine CW. e.g., Microfinance customer v. Corp. customer (risky) with high NW. Creditworthiness of the user may be defined as when someone is given loan credit probability of same being returned on time with due interest. Ability to repay can be assessed from Affluence Index coupled with financial data sets, however, LI will also provide colour to the intent behaviour to repay by evaluating the available Data sets other than financial (interior, exterior, aerial and other) by automated, objective and technological methods (identifying Lifestyle Index).

Currently, the conventional arts does not provide any means to identify the Lifestyle Index of a user. The present application overcomes the challenges of the conventional art by providing means to evaluate lifestyle index with objective and automated methods of digital data collection and process to establish Lifestyle Index, a digital lifestyle Index.

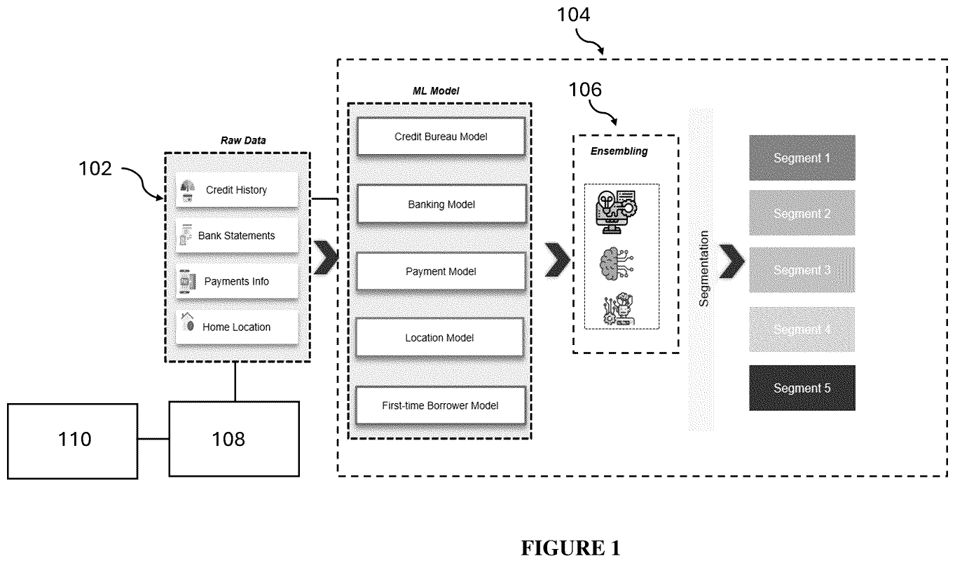

FIG. 1 illustrates a system 100 for determining creditworthiness of a user, in accordance with one embodiment of the present disclosure. The system 100 comprises a receiving module 102, a lifestyle index determination module 104, an ensembling module 106, a memory 108 and a processor 110. The processor 110 is coupled to the memory 108, the receiving module 102, the lifestyle index determination module 104 and the ensembling module 106.

The receiving module 102 is configured to receive user related data from one or more data sources. In one embodiment, the user related data includes financial related data and the location related information of user's residence. Some of the examples of financial data includes, but not limited to, credit history of the user, bank statements of the user, payment related information relatd to the user. Further, the location information of the user's residence includes, but not limited to, analysisng satellite images of the user's residence (aerial location), exterior images of the user's residence and interior of the user's residence. Each of this will be explained in detail below.

The data received by the receiving module 102 is fed into a lifestyle index determination module 104. Based on the user related data, the lifestyle index determination module is configured to determine a lifestyle index of the user. Once the lifestyle index has been determined, the processor is configured to determine the creditworthiness of the user based on the lifestyle index.

The lifestyle index determination module 104 contains various machine learning models and an ensemling module. The machine learning model is further divided into a plurality of models, such as but not limited to, credit Bureau model, banking model, payment model, location model and first-time borrower model. In one embodiment, the machine learning model is stored in the memory 106.

The machine learning model takes as input the user related data received by the receiving module 102. For example, the data related to the credit history of the user may be fed to the credit bureau model. The credit bureau model may analyse the credit history of the user and identify one or more parameters related to creditworthiness of the user. The one or more parameters may include, but not limited to late payment history, high credit utilization, recent loan inquiries, or default patterns. The identified parameters may then be provided as inputs to an ensembling module, which combines these outputs with data from other models or data sources to generate a comprehensive risk assessment or user classification.

Similarly, the data related to the payment history of the user is fed to the payment model. The payment model is configured to analyze such data to identify patterns, trends, and potential risk factors associated with the user's payment behavior. For example, the payment model may evaluate the frequency of late payments, missed payments, payment amounts, and consistency of payment schedules to generate one or more predictive outputs. These outputs may indicate the likelihood of future payment defaults, payment reliability, or overall financial discipline of the user. The analysis of the payment model is done to determine the creditworthiness of the user. The output from the payment model is provided as input to an ensembling module, which combines these outputs with data from other models to generate a comprehensive risk assessment or user classification.

Further, the data related to the bank statements of the user is fed to a banking model. The banking model analyzes transactional patterns, account balances, cash flow trends, and other financial indicators derived from the user's bank statements. For example, the banking model may identify regular income deposits, recurring expenses, unusual transactions, or fluctuations in account balances to generate one or more predictive outputs. The output from the banking model is provided as input to an ensembling module, which combines these outputs with data from other models to generate a comprehensive risk assessment or user classification.

Further, the financial data of the user is also fed to the first-time borrower model. This model assesses the financial behavior, creditworthiness, and risk profile of users who may have limited or no formal credit history. The first-time borrower model analyzes available financial data, such as income patterns, spending behavior, banking activity, and any alternative data sources, to generate predictive indicators of the user's ability and likelihood to repay borrowed amounts. The output from the first-time borrower model is provided as input to an ensembling module, which combines these outputs with data from other models to generate a comprehensive risk assessment or user classification.

The ensembling module 106 receives the output from the credit bureau model, banking model, payment model, location model and first-time borrower model. The ensembling module 106 applies one or more ensembling techniques, such as bagging, boosting, stacking, weighted averaging, or majority voting, to combine the outputs from the different models into a unified ensembled output. The ensembled output represents an aggregated or consensus prediction that takes into account the strengths and complementary characteristics of the individual models. By leveraging ensembling, the system reduces the likelihood of inaccurate predictions resulting from overfitting or bias within any single model, thereby improving the overall performance and confidence level of the predictions.

Based on the ensembled output, a plurality of user segments are generated. The segmentation process involves classifying users into distinct groups based on the ensembled output, such as probability scores, risk assessments, or other derived attributes. Each segment corresponds to a specific classification of users, which may be defined by similar behaviors, characteristics, preferences, or predicted outcomes. For example, may be segmented based on their lifestyle so that creditworthiness of the user can be easily determined.

The location model will now be explained. The location model takes as input location information of the user's residence. The location information related to the user's residence includes, but not limited to, the satellite image of the user's residence, the exterior images of the user's residence, and the interior images of the user's residence. Each of these images are used to identify the lifestyle of the user. The location information is especially helpful when the the output from the other models indicates in negative. For example, when the credit history, bank statements and payment information of the user indicates that the user is not eligible for credit, the determination of the lifestyle of the user based on the location of the user's residence helps to substantiate in determining creditworthiness of the user. This is explained in detail below.

In one embodiment, the lifestyle may be determined based on behavior of the user. This behavioral data may include factors such as spending habits, transaction categories, frequency of purchases, preferred merchants, travel patterns, utility usage, and other interaction data derived from financial or digital activity. The data may be collected from various sources including mobile applications, transaction logs, bank statements, or third-party platforms, and may be processed using one or more behavioral analysis models.

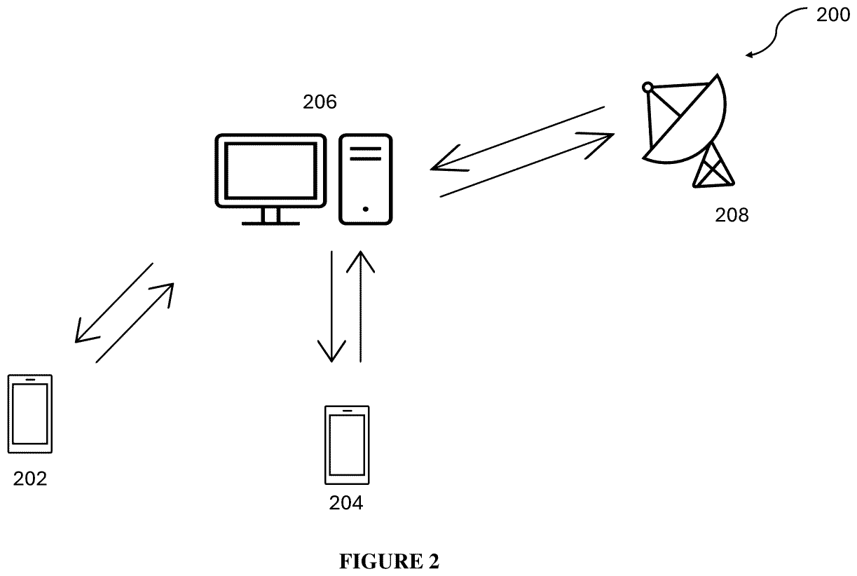

Referring to FIG. 2, a system 200 for evaluating lifestyle index of a user based on location information of the user's residence is now explained, in accordance with one embodiment of the present invention. The system 200 comprises at least two user devices 202 and 204, a central server 206 and a satellite 208. Each of the user device 202 and 204 are in communication with the central server 206. In one embodiment, the communication between the user device 202 and 204 with the central server 206 is a two-way communication indicating that both the user devices 202, 204 and the central server 206 can send and receive the data to/from each other. In one embodiment, the user device may include a mobile device, a smartphone, a tablet, a laptop, a computer, etc. The user device may run a mobile application which may help to perform the functioning of the present invention.

In one embodiment, the user device 202 is operated by a user with whom the company is interacting with and the user device 204 is operated by an employee of the company. For example, considering the company as a company which handles loan applications of the user, the user device 202 is operated by the user who is applying for the loan while the user device 204 is operated by the employee who is providing the loan to the user. The server 206 in this case would be a central processing system of the company.

All the data transmitted by the user devices 202, 204 and the satellite 208 are processed at the server 206. The server 206 is responsible for analyzing the data, processing the data and producing an outcome. The server 206 is also responsible for performing image processing techniques on the data received from the user devices 202 and 204 (as explained later). The server 206 is also responsible for performing machine learning techniques on the data/images received from the devices 202, 204 and also the data received from the satellite 208.

In one embodiment, the data received from the satellite 208 may include the location related data of the user. The location related data may include the latitude and longitude of the location of the user. The location related data also includes one or more satellite images corresponding to the location of the user device 202, 204. In one embodiment, the satellite 208 may be a global positioning system based satellite. The server 206 receives the location information from the user device 202 and 204 and transmits the location information to the satellite 208 which may then convert the location information of the user into latitude and longitude format. In another embodiment, the user device 202, 204 may directly communicate with the satellite 208 to identify the current location of the user device 202, 204. Once this identified, the current location of the device 202, 204 can be transmitted to the server 206 for further processing.

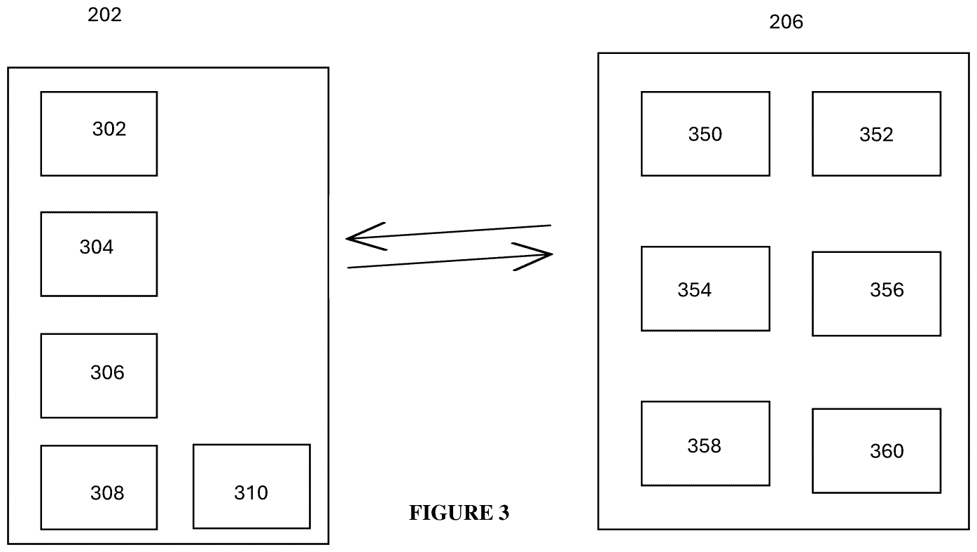

Referring to FIG. 3 now, a block diagram of the user device 202, 204 and the server 206 is illustrated, in accordance with one embodiment of the present invention. The user device 202, 204 comprises a memory 302, a location determination unit 304, a transceiver 306, an image sensor 308 and a processor 310. The server 206 comprises of a memory 350, a transceiver 352, an image processing unit 354, a machine learning unit 356, a score calculation unit 358 and a processor 360.

To start with, the location determination unit 304 present in the user device 202, 204 captures the current location of the user device 202, 204. Once the current location has been captured, the location is transmitted to the server 206 via the transceiver 306. In an alternative embodiment, the current location of the user device 202, 204 may be manually input by the user in an application running in the user device 202, 204. Considering an example of a user applying for a loan, the location may be captured when the user applies for the loan with the company. The location in this case may be captured and transmitted by the user operating the user device 202 or/and by an employee of the company visiting the location of the user via the user device 204.

The server 206 transmits the location received from the user device 202, 204 to the satellite 206 via the transceiver 352 to fetch the longitude and latitude along with the satellite images corresponding to the location of the user. The satellite images may provide an aerial view of the location of the user along with the nearby areas corresponding to the location of the user. In one embodiment, there may be a location server (not shown) which may store the satellite images corresponding to the location of the user and the server 206 may communicate with the location server to fetch the satellite images corresponding to the location of the user. Conversion of address into latitude and longitude is done by existing prior art of geo mapping services like Google maps or Bing Maps

The satellite images corresponding to the location of the user are fetched and stored in the memory 350. The image processing unit 354 along with the machine learning unit 356 may analyze the top view of the building/dwelling where the user lives along with the nearby areas to identify the objects present in the satellite images. The image processing unit 354 along with the machine learning unit 356 applies one or more image processing techniques and machine learning techniques to understand the objects present in the image. The objects may include, but are not limited to, the buildings, roads, trees, and other information related to the vicinity.

Along with the identification of the objects from the satellite images, the machine learning unit 356 is configured to extract further details about the objects present in the image. For example, the machine learning unit 356 applies machine learning techniques to classify the buildings as single storied/multi-storied, other building characteristics such as area of the building, building size, architectural style, etc. Along with the details of the building where the user lives, the details about the neighborhood of the building are also identified, such as locality features, neighborhood attributes, road infrastructure, structural density. Once these details are analyzed, the score calculation unit 358 is configured to calculate an aerial Lifestyle Index of the user which would be indicative of the lifestyle of the user.

The classification of the location of the user and the neighborhood of the user can be into affluent locality vs average locality. These are merely for exemplary purposes and the classification may include several other categories. Thus, for example, if the user resides in a multi-storied building having similar building(s) nearby and/or also having good quality roads, the user may be classified as living in an affluent locality. Accordingly, the user may be assigned a better aerial Lifestyle Index as compared to someone living in an average locality.

The memory 350 stores a machine learning model therein. The machine learning model is trained with a plurality of sample data set to identify the objects in the satellite images. For example, the sample data includes a plurality of images of buildings, roads, trees, parks, etc. Further, the machine learning model may also be trained to determine different attributes such as area of the building, number of floors in the building, etc. In one embodiment, the machine learning model may use supervised learning techniques for learning and classification.

In an alternative embodiment, the machine learning unit 356 does not attempt to individually identify specific features or other classifying characteristics from the buildings. Instead, it uses a deep learning neural network trained to produce embeddings of images, which are further trained via supervised learning to a score that is provided to represent the lifestyle index of the user. The implicit understanding of features that lead to higher vs lower weightages on various characteristics in the image are left to be learnt by the training of such a neural network—which may or may not produce any specific human understandable features.

In a specific implementation such a deep learning network may consist of a Multimodal Large Language Model (MLLM) or Visual Language Model (VLM), and the method of training such a model may consist of a multi-shot learning prompt with specific examples of images associated with users with known lifestyle index.

In a specific implementation such a multi-shot prompt may use examples derived from previously known users whose creditworthiness is well-understood, for example from credit bureau reports or from previous history of loan servicing performance.

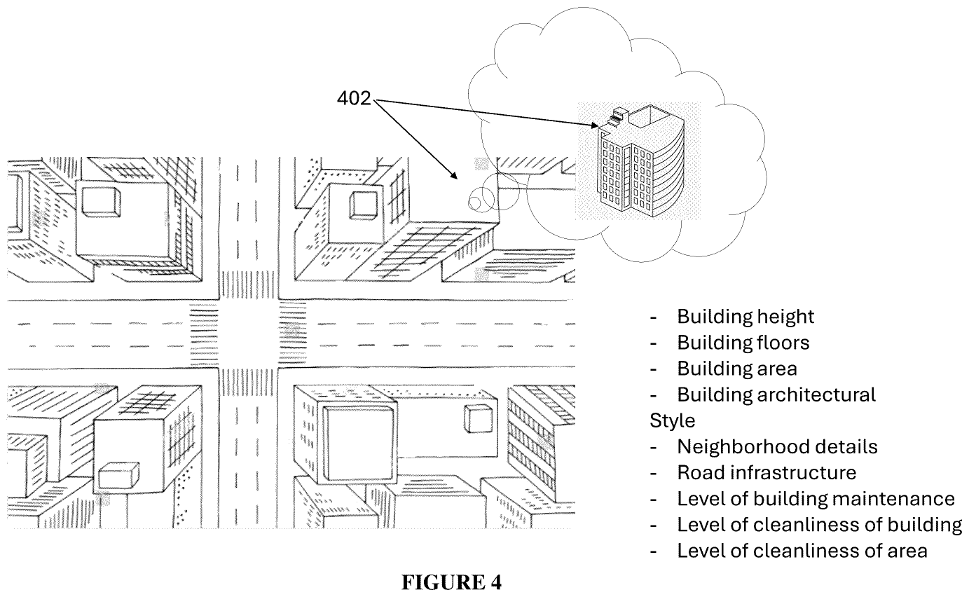

Referring to FIG. 4 now, an example of the aerial view of the location of the user is disclosed. As shown in FIG. 4, the user may reside in the building 402. Once the location of the user device 202 is captured (i.e., location of building 402) and transmitted to the server 206, the satellite images corresponding to the location of the user are fetched as already explained above. The image processing unit 354 along with the machine learning unit 356 analyzes the satellite images captured corresponding to the location of the user (i.e., location 402) and identifies one or more attributes corresponding to the location of the user (i.e., the location 402) and neighborhood. As explained above, the one or more attributes includes, but are not limited to, building height, building floors, building area, building architectural style, neighborhood details, road infrastructure, level of building maintenance, level of cleanliness of building, level of cleanliness of area, etc. Based on the above analysis, the score calculation unit 358 assigns the aerial Lifestyle Index to the user.

In an alternative embodiment, the machine learning unit 358 does not attempt to individually identify specific features from the buildings or other classifying characteristics. Instead, it uses a deep learning neural network trained to produce embeddings of images, which are further trained via supervised learning to a score that is provided to represent the lifestyle index of the user. The implicit understanding of features that lead to higher vs lower weightages on various characteristics in the image are left to be learnt by the training of such a neural network—which may or may not produce any specific human understandable features.

In a specific implementation such a deep learning network may consist of a multimodal Large Language Model or Visual Language Model, and the method of training such a model may consist of a multi-shot learning prompt with specific examples of images associated with users with kown lifestyle index.

In a specific implementation such a multi-shot prompt may use examples derived from previously known users whose creditworthiness is well-understood, for example from credit bureau reports or from previous history of loan servicing performance.

Referring back to FIG. 3, the image processing unit 354 and the machine learning unit 356 also performs analysis of the images manually captured by the user (e.g., an employee). As explained above, an employee working in a company may visit the location of the user along with the user device 204. The employee captures the images of the building of the user where the user resides (for example, the location 402 as mentioned in FIG. 4) via the image sensor 308 present in the user device 204. The images of the building include the exterior view of the building where the user resides. The images in this case may be taken from the front view of the building so that the complete height of the building is captured.

In one embodiment, the employee may capture the image of the building where the user lives along with the image of the user. The user may be located in front of the building. This image having a human and building in background are analyzed for identifying similar attributes as explained above. In some cases, where only the image of the building is required to be captured, the image of the human/user present in the image can be cropped or hazed using the image processing techniques to avoid any unintended bias in the embodiment in addition to protect the privacy of the user(s).

The image processing unit 354 employs advanced image processing techniques to extract detailed information about the one or more physical attributes related to the user's residence. The one or more physical attributes related to the user's residence includes, but not limited to, construction material, architectural features, roof type, condition of the paint, and overall structural integrity, size of the building, quality of doors, walls, and other aesthetics attributes of the building.

The machine learning unit 356 may further process the images analyzed by the image processing unit 354 to classify the constructional material, architectural features, roof type, condition of paint and overall structural integrity into one or more categories. For example, the constructional material and the condition of the paint may be classified into good category or the poor category. The classification under good category of the constructional material and paint condition may be indicative of better lifestyle of the user as compared to the classification of the constructional material and paint condition under poor category. Another way to classify user dwellings is by categorizing them as either Kachha buildings, which are adobe-style dwellings typical of the Indian subcontinent, or Pakka buildings, which are constructed with brick or mortar.

Based on the classification of the user based on the lifestyle of the user, the score calculation unit 358 calculates an exterior lifestyle index of the user. The exterior lifestyle index is calculated based on the classification of the user according to the lifestyle of the user. A good exterior lifestyle index is indicative of the user living a luxurious life and living in good quality dwelling. On the other hand, the poor/average exterior lifestyle index is indicative of the user not living a luxurious life. The indication of the good/poor exterior Lifestyle Index may be based on a threshold value.

The memory 350 stores a machine learning model therein. The machine learning model is trained with a plurality of sample data set to identify the one or more attributes related to the building of the user. For example, the machine learning model may be trained to determine different attributes such as exterior aesthetics of the building, the condition of the paint of the building, construction material, architectural features, roof type, condition of the paint, and overall structural integrity, size of the building, quality of doors, walls. In one embodiment, the machine learning model may use supervised learning techniques for learning and classification.

In an alternative embodiment the machine learning unit 356 does not attempt to individually identify specific features from the buildings or other classifying characteristics. Instead it uses a deep learning neural network trained to produce embeddings of images, which are further trained via supervised learning to a score that is provided to represent the lifestyle index of the user. The implicit understanding of features that lead to higher vs lower weightages on various characteristics in the image are left to be learnt by the training of such a neural network—which may or may not produce any specific human understandable features.

In an alternative implementation, the machine learning unit 356 and the image processing unit 354 may be combined to be the same processing unit that embodies the previously described alternative embodiment.

In a specific implementation such a deep learning network may consist of a multimodal Large Language Model (MLLM) or Visual Language Model, and the method of training such a model may consist of a multi-shot learning prompt with specific examples of images associated with users with kown lifestyle index.

In a specific implementation such a multi-shot prompt may use examples derived from previously known users whose creditworthiness is well-understood, for example from credit bureau reports or from previous history of loan servicing performance.

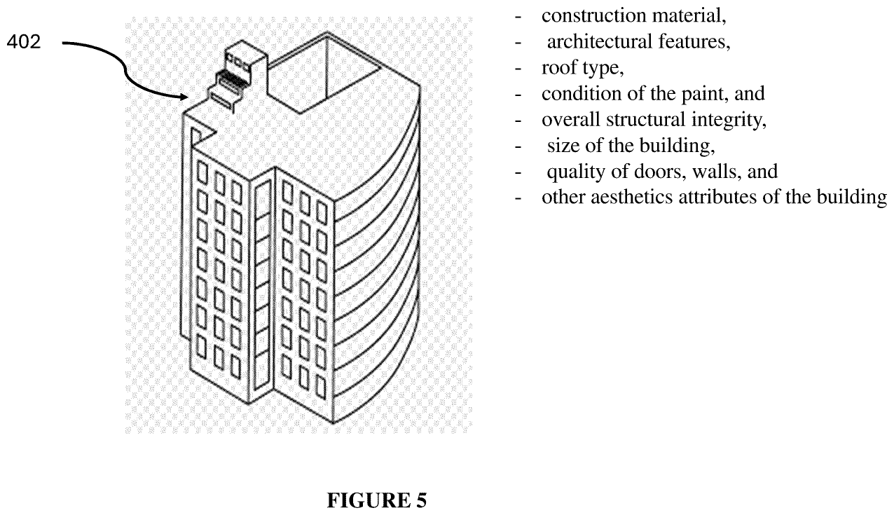

Referring to FIG. 5 now, a building 402 where the user resides is shown. The employee of the company captures the front image of the building 402 so that the complete analysis of the building 402 can be performed. For example, as mentioned above, the image analysis unit 354 and the machine learning unit 356 analyses the front images of the building 402 and identifies one or more attributes related to the building 402. The exterior lifestyle index of the dwelling can be directly derived by applying image deep learning techniques including but not limited to visual language models and/or multimodal large language models. When using such techniques, either the models can directly output the lifestyle index or the lifestyle index can be calculated based on techniques can output the attributes which can then be used in classification. The one or more attributes related to the building may include, but are not limited to, exterior aesthetics of the building, the condition of the paint of the building, construction material, architectural features, roof type, condition of the paint, and overall structural integrity, size of the building, quality of doors, walls. The exterior Lifestyle Index can then be calculated for the user based on the identified one or more attributes.

Referring back to FIG. 3, the image sensor present in the user device 202 may record video of the user during a user authentication session. The company may perform user authentication by interacting with the user while the user is present at the residence. The interaction may be performed using a front image sensor (not shown) present in the user device 202. In one embodiment, the user authentication includes video KYC (know your customer) authentication done by financial institutions. The user device 202 is in communication with the server 206 during this user authentication session.

During this authentication process data capture will be used for assessing the credit worthiness of the user and for the said purpose the access of user's image sensor is taken. During the user authentication session, the company (or an agent/employee representing the company) may ask the user to capture an image of one or more documents of the user by switching from the front image sensor to the rear image sensor of the user device. During the process, only the image/footage which captures the interior of user dwelling and lifestyle is used. In addition, the machine learning process would only capture the rear images to avoid any bias based on customer physical attributes. The one or more KYC documents of the user may relate to authenticity of the user. In one embodiment, the one or more documents may include of the users, permanent account number (PAN) of the user, passport details of the user, etc. Other captured image/footage like the user's physical attributes and/or KYC documents will not be used in the calculation of interior Lifestyle Index, however same shall be used for KYC authentication purpose. The images of these one or more documents may be required to authenticate the user on the government authority portal.

The user may capture the image of the one or more documents using the image sensor 208 present on the rear side of the user device 202. While the user is switching between the front image sensor to the rear image sensor 308, the user device 202 captures the images of inside of the dwelling of the user. In one embodiment, the user device 202 may capture video of the inside the dwelling of the user. The captured images/video is transmitted to the server 206 via the transceiver 306.

The image processing unit 354 along with the machine learning unit 356 performs image processing techniques and the machine learning techniques to identify one or more objects present in the interior image of the dwelling of the user. The one or more objects includes, but are not limited to, electronic items of the user, furniture item and other visible condition of the user's dwelling. The other visible condition of the dwelling may include the condition of the furniture, walls, paints, etc. The identified one or more objects may be indicative of the lifestyle of the user. For example, expensive electronic items and good quality furniture may indicate a better lifestyle of the user.

The machine learning unit 356 classifies the user based on the identification of the one or more objects present in the interior image of the dwelling of the user. For example, the user may be classified as having a good lifestyle based on the identification of expensive electronic items and/or good quality furniture. The score calculation unit 358 calculates an interior lifestyle index based on the classification of the user. For example, the user classified as having a good lifestyle is assigned a good interior lifestyle index. The good/bad interior lifestyle index is calculated based on the comparison of interior lifestyle index with a predefined threshold.

In an alternative embodiment the machine learning unit 356 does not attempt to individually identify specific features from the buildings or other classifying characteristics. Instead it uses a deep learning neural network trained to produce embeddings of images, which are further trained via supervised learning to a score that is provided to represent the lifestyle index of the user. The implicit understanding of features that lead to higher vs lower weightages on various characteristics in the image are left to be learnt by the training of such a neural network—which may or may not produce any specific human understandable features.

In an alternative implementation the machine learning unit 356 and the score processing unit 358 may be combined to be the same processing unit that embodies the previously described alternative embodiment.

In a specific implementation such a deep learning network may consist of a multimodal Large Language Model or Visual Language Model, and the method of training such a model may consist of a multi-shot learning prompt with specific examples of images associated with users with kown lifestyle index.

In a specific implementation such a multi-shot prompt may use examples derived from previously known users whose creditworthiness is well-understood, for example from credit bureau reports or from previous history of loan servicing performance.

In one embodiment, the memory 350 may store a machine learning model. The machine learning model may be trained based on sample data containing a plurality of images of items present inside a house. For example, the sample data includes a plurality of images of electronic items, furniture items such as sofa, table, lamp shades, etc. The machine learning model may also be trained to determine different condition of the furniture/walls of the dwelling. In one embodiment, the machine learning model may use supervised learning techniques for learning and classification.

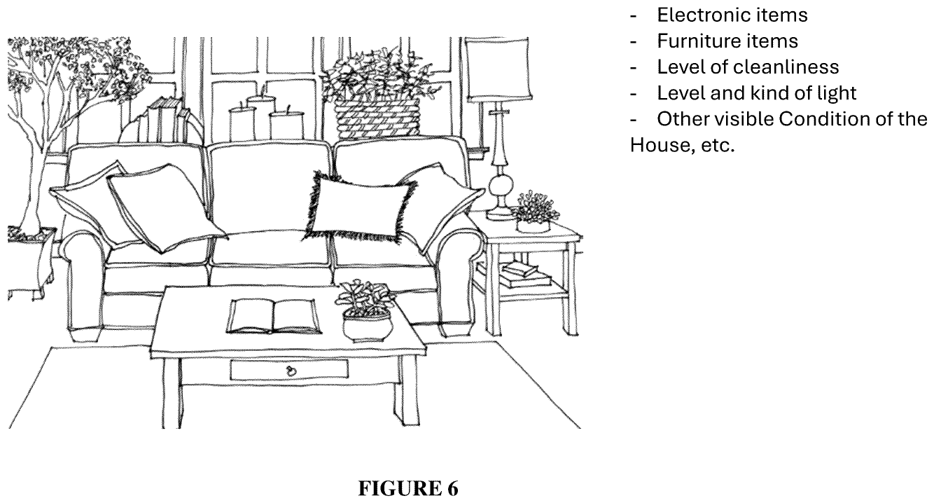

Referring to FIG. 6 now, an example of the furniture and other items present inside the dwelling of the user is illustrated. As explained above, as soon as the image sensor present on the user device 202 is switched from the front to rear image sensor, the image/video of the interior of the dwelling of the user is captured. The image/video is then analyzed to identify one or more objects such as electronic items, furniture items, level of cleanliness, level and kind of light present/available inside the dwelling of the user and other visible condition of the dwelling of the user. As shown in the figure, the one or more objects that can be identified from the image includes, sofa, table, lamp shades, books, etc. The interior Lifestyle Index is then calculated based on the identification of the objects present inside the dwelling of the user. As explained above, the expensive items present in the dwelling is indicative of a good lifestyle of the user. Hence, a good interior Lifestyle Index can be calculated for the user classified as having good lifestyle. Along with the images, direct calculation of video/image data (video and images both) can also be performed by using the machine learning model.

Referring back to FIG. 3, once the aerial lifestyle index, exterior lifestyle index and interior lifestyle index are calculated by the score calculation unit 358, the processor 360 computes a wholistic lifestyle score based on the aerial lifestyle index, exterior Lifestyle Index and interior Lifestyle Index. The final lifestyle score may be computed using generative AI (GenAI) techniques. In an alternative embodiment, the aerial images, the exterior images and the interior images of the dwelling of the user can be directly used by the processor 360 to compute the final lifestyle score without separately calculating the aerial lifestyle index, exterior lifestyle index and interior lifestyle index.

The Customer lifestyle index score is then merged with other scores obtained from other data sources. For example, in the case of financial institutions, for a user applying for a loan, the final creditworthiness index score as calculated above is merged with other scores like Bureau scores, Banking score and other alternate data scores to generate the customer underwriting eligibility. The resulting Customer Lifestyle Index Score serves as a valuable metric for understanding the physical aspects of customer well-being and can be utilized in various applications, including risk assessment, marketing targeting, and financial services provisioning. The customer lifestyle index can be utilized as one of the factors to decide whether to disburse the loan to the user.

In one embodiment, at least one index can be skipped in calculating the lifestyle index of the user. For example, if the aerial lifestyle index is above a predetermined threshold value, the server 206 may skip computing the other two indices, i.e., exterior lifestyle index and the interior lifestyle index. In this case, the final lifestyle score can be based on only the exterior lifestyle index.

In yet another embodiment, even if the aerial lifestyle index is above a predetermined threshold value, the server 206 may still calculate the exterior as well as the interior lifestyle index to compute the final creditworthiness index score. However, in this case, the server 206 may assign weights to each index where the aerial lifestyle index may be assigned a higher weight as compared to the exterior and interior lifestyle index.

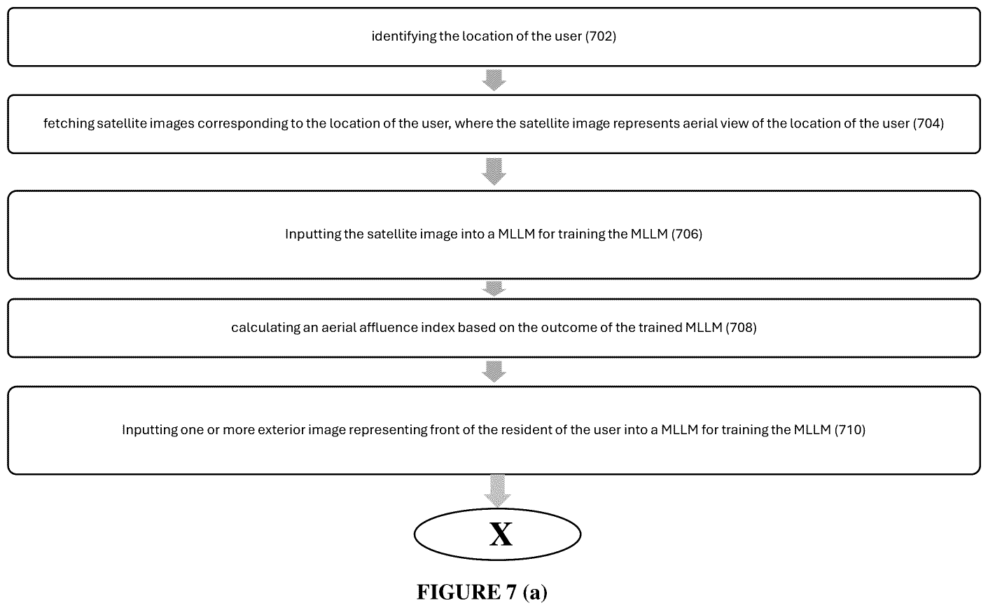

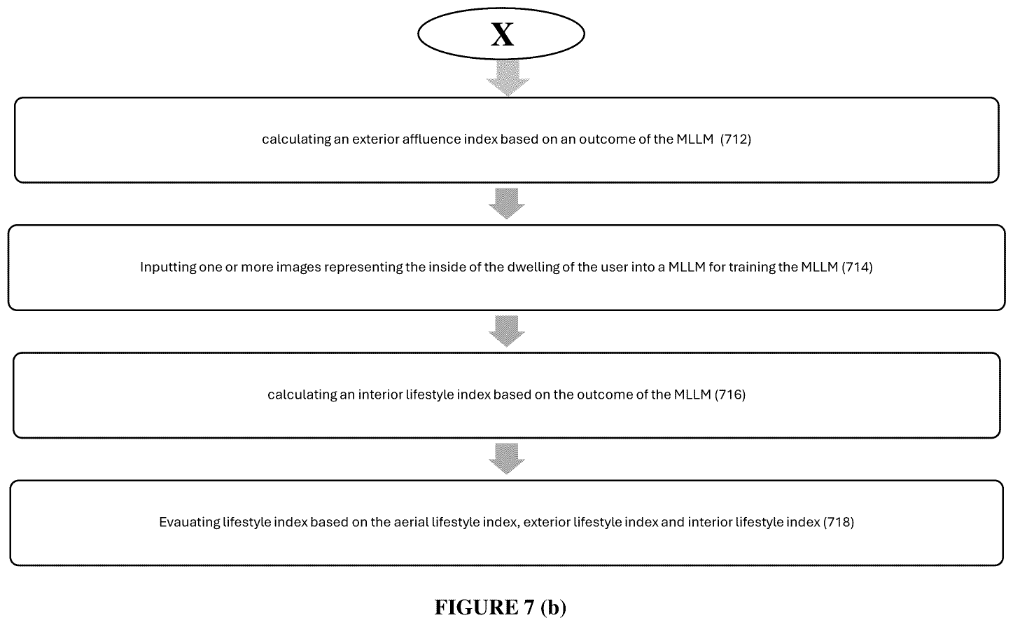

Referring to FIGS. 7(a) and 7(b) now, a flowchart of a method for assessing the lifestyle of the user is disclosed. At step 702, the method comprises identifying the location of the user. The location of the user can be determined by the user device 202 and/or the user device 204. At step 704, the method comprises fetching satellite images corresponding to the location of the user, where the satellite image represents aerial view of the location of the user. At step 706, the method comprises inputting the satellite image into a MLLM for training the MLLM. At step 708, the method comprises calculating an aerial Lifestyle Index based on an outcome from the MLLM. At step 710, the method comprises inputting one or more image representing front of the resident of the user into the MLLM for training the MLLM. The front images of the resident of the user are captured by the user device 204. At step 212, the method comprises calculating an exterior Lifestyle Index based on the outcome of the MLLM.

At step 714, the method comprises inputting one or more images representing the inside of the dwelling of the user to the MLLM to train the MLLM. At step 716, the method comprises calculating an interior lifestyle index based on the outcome of the MLLM. At step 718, the method comprises evaluating lifestyle index based on the aerial lifestyle index, exterior lifestyle index and interior lifestyle index.

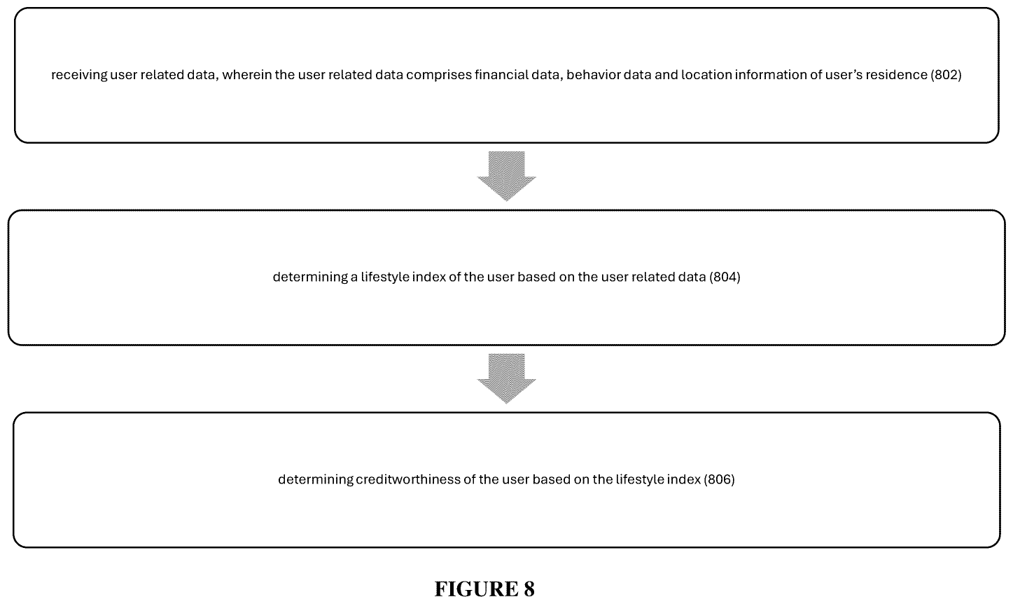

Referring to FIG. 8 now, a flowchart of a method for determining creditworthiness of the user is illustrated, in accordance with one embodiment of the present disclosure. At step 802, the method comprises receiving user related data, wherein the user related data comprises financial data and location information of user's residence. At step 804, the method comprises determining a lifestyle index of the user based on the user related data. At step 806, the method comprises determining creditworthiness of the user based on the determined lifestyle index.

In the context of this document, the “memory” (also referred to as “computer-readable media” or “computer-readable medium”) may be any non-transitory media or medium or means that can contain, store, communicate, propagate or transport the instructions for use by or in connection with an instruction execution system, apparatus, or device, such as a computer. The term “non-transitory,” as used herein, is a limitation of the medium itself (i.e., tangible, not a signal) as opposed to a limitation on data storage persistency (e.g., RAM vs. ROM). In one embodiment, the various modules present in the present disclosure may be hardware components, such as a processor, for implemting the method steps.

The at least one processor in this document can be a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor may also be implemented as a combination of computing devices, e.g., a combination of a DSP and a microprocessor, a plurality of microprocessors, one or more microprocessors in conjunction with a DSP core, or any other such configuration. The processor can include the logic circuitry with hardware, firmware, and software architecture frameworks for facilitating image processing.

The steps of a method (e.g., method 700 and 800) described in connection with the embodiments disclosed herein may be embodied directly in hardware, in a software module executed by the at least one processor, or in a combination of the two. If implemented in software, the functions may be stored on or transmitted over as one or more instructions or code on a tangible, non-transitory computer-readable medium (e.g., the at least one memory). A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the processor such that the processor can read information from, and write information to, the storage medium.

In the several embodiments provided in this application, the disclosed system, device, and method may be implemented in another manner. For example, some features of the method embodiments described above may be ignored or not performed. The described device embodiments are merely examples.

The term based on is not exclusive and allows for being based on additional factors not described unless the context clearly dictates otherwise. In addition, throughout the specification, the meaning of “a”, “an” and “the” include plural references. The meaning of “in” includes “in” and “on”

As used herein the terms “and” and “or” may be used interchangeably to refer to a set of items in both the conjunctive and disjunctive in order to encompass the full description of combinations and alternatives of the items. In either case, the set is to be interpreted as meaning each of the items singularly as alternatives, as well as any combination of the listed items.

The description above merely illustrating the technical spirit of the present disclosure, and various changes and modifications may be made by those skilled in the art without departing from the essential characteristics of the present disclosure. Therefore, the embodiments of the present disclosure described above may be implemented separately or in combination with each other.

The embodiments disclosed in the present disclosure are intended to illustrate rather than limit the scope of the present disclosure, and the scope of the technical spirit of the present disclosure is not limited by these embodiments. The scope of the present disclosure should be construed by claims below, and all technical spirits within a range equivalent to claims should be construed as being included in the right scope of the present disclosure.

While only certain features have been illustrated and described herein, many modifications and changes will occur to those skilled in the art. It is, therefore, to be understood that the appended claims are intended to cover all such modifications and changes as fall within the true spirit of the disclosure.

We claim:

1. A method for determining creditworthiness of a user, the method comprising:
receiving user related data, wherein the user related data comprises financial data, behavior data and location information of user's residence;
determining a lifestyle index of the user based on the user related data; and
determining creditworthiness of the user based on the lifestyle index.

2. The method as claimed in claim 1, wherein determining location information of the user's residence comprises:
determining an aerial lifestyle index of the user,
determining an exterior lifestyle index of the user,
determining an interior lifestyle index of the user.

3. The method as claimed in claim 2, wherein the aerial lifestyle index is determined based on an image analysis of satellite images of the user's residence.

4. The method as claimed in claim 2, wherein the exterior lifestyle index is determined based on analysis of one or more attributes corresponding to the location information of the user's home.

5. The method as claimed in claim 2, wherein the interior lifestyle index of the user is determined based on analysis of one or more objects present inside the user's home.

6. A system for determining creditworthiness of a user, the system comprising:
a receiving module configured to receive user related data, wherein the user related data comprises financial data, behavior data and location information of user's residence;
a lifestyle index determination module configured to determine a lifestyle index of the user based on the user related data; and
a processor configured to determine creditworthiness of the user based on the lifestyle index.

7. The system as claimed in claim 6, wherein determining location information of user's residence comprises:
determining an aerial lifestyle index of the user,
determining an exterior lifestyle index of the user,
determining an interior lifestyle index of the user.

8. The system as claimed in claim 7, wherein the aerial lifestyle index is determined based on an image analysis of satellite images of the user's residence.

9. The system as claimed in claim 7, wherein the exterior lifestyle index is determined based on analysis of one or more attributes corresponding to the location information of the user's home.

10. The system as claimed in claim 7, wherein the interior lifestyle index of the user is determined based on analysis of one or more objects present inside the user's home.
